(19) United States
(12) Patent Application Publication
(10) Pub. No.: US 2011/0083785 A1
(43) Pub. Date: Apr. 14, 2011

(54) ELECTRODE FORMING METHOD

(75) Inventors: Kazuo Onishi, Osaka (JP); Shingo Sewa, Osaka (JP)

(73) Assignee: EAMEX CORPORATION, Osaka (JP)

(21) Appl. No.: 12/975,873

(22) Filed: Dec. 22, 2010

Related U.S. Application Data
(62) Division of application No. 10/525,202, filed on Apr. 14, 2006.

(30) Foreign Application Priority Data
Aug. 23, 2002 (JP) 2002-244196
Oct. 25, 2002 (JP) 2002-311696

(51) Int. Cl. B05D 5/12; B31B 1/60

(52) U.S. Cl. 156/60; 427/77

(57) ABSTRACT

The present invention provides an electrode forming method in which an electrode layer is formed on a solid electrolyte, capable of obtaining an electrode layer having a large electrode surface area, decreasing the number of steps required in formation of the electrode layer and reducing a human labor and time. The electrode forming method of the invention is an electrode forming method, in which a metal salt solution and a reducing agent solution are disposed on respective both sides of a solid electrolyte form and the metal salt solution is caused to pass through the solid electrolyte form by osmosis to thereby deposit a metal near the interface on the reducing agent solution side of the solid electrolyte form to thereby form the electrode on the solid electrolyte form.

### CROSS-REFERENCE TO RELATED APPLICATIONS

This application is a divisional of U.S. application Ser. No. 10/525,202, filed on Apr. 14, 2006, which is a 371 of International Application No. PCT/JP2003/10679 filed on Aug. 25, 2003, which is based upon and claims the benefit of priority from prior Japanese Patent Application No. 2002-311696, filed on Oct. 25, 2002 and Japanese Patent Application No. 2002-244196, filed on Aug. 23, 2002, the entire contents of which are incorporated herein by reference.

### TECHNICAL FIELD

The present invention relates to an electrode forming method for forming an electrode near a surface of a solid electrolyte and a producing method of an actuator in which an electrode is formed using the electrode forming method.

### BACKGROUND ART

An actuator capable of bending and displacement, particularly a polymer actuator, has been employed as a driving part of a catheter or the like because of its flexibility. The actuator can be used as an actuator that is constituted of an ion exchange resin film and metal electrodes connected to each other on a surface thereof and in which the ion exchange molded product can be subjected to curvature or other kinds of deformation by applying a potential difference between the metal electrodes in a state of the ion exchange resin film including water. In a method to obtain the actuator according to Japanese Patent No. 2961125, a platinum complex or a gold complex is adsorbed to the ion exchange resin film, the complex is reduced with a reducing agent, an electrode is formed with electroless plating and the pair of an adsorption step and a reduction step was repeated. Since a metal grows in a direction toward the interior of an ion exchange resin film by the electrode forming method, it is possible to increase a metal quantity of the plating applied onto the ion exchange resin film and to attain a large electrode surface area, thereby enabling an actuator large in bending and displacement to be obtained. Particularly, in the above mentioned electrode forming method, a metal electrode layer formed on the ion exchange resin film, which is a solid electrolyte, has a fractal structure in section and has a large electrode surface area, which makes it possible to obtain an actuator large in bending and displacement.

However, in order to obtain an actuator having a large electrode surface area, since a necessity arises for forming an electrode with an electrode forming method using the electroless plating, it takes several days in production because of repetition of the pair of an adsorption step and a reduction step. Hence, in order to produce a great number of the actuators, it is necessary to shorten a step of forming an electrode. In addition, a necessity arises for a human labor and time consumed in pulling up an ion exchange resin film in transition from an adsorption step to a reduction step or a reduction step to an adsorption step.

A proposal has been made of a reducing agent osmosis method for forming an electrode layer on an ion exchange resin film without repeating the pair of an adsorption step for a metal salt solution and a reduction step using a reducing agent in JP-B No. 56-36873, in which a metal salt solution at a concentration of 3 wt % is placed in a space on one surface of the ion exchange film, while a reducing agent solution at a concentration of 10 wt % is caused to pass through the ion exchange film from the other side surface of the film by osmosis to thereby deposit a metal layer on the one film surface on the side of the metal salt solution. The method is suited for obtaining an electrode with a uniform thickness, whereas it is difficult to obtain a large electrode surface area, thereby disabling an actuator large in bending or displacement and having a large electrode surface area as mentioned above to be obtained.

That is, it is a task of the invention to provide a method for forming an electrode layer formed on a solid electrolyte capable of obtaining an electrode layer having a large electrode surface area, decreasing the number of steps required in formation of the electrode layer and reducing a human labor and time.

### DISCLOSURE OF THE INVENTION

An electrode forming method of the invention of the application is directed to an electrode forming method, in which a metal salt solution and a reducing agent solution are disposed on respective both sides of a solid electrolyte form and the metal salt solution is caused to pass through the solid electrolyte molded product by osmosis to thereby deposit a metal near the interface on the reducing agent solution side of the solid electrolyte molded product and an electrode is formed in the solid electrolyte form. With the electrode forming method adopted, it is possible to obtain an electrode layer having a large electrode surface area and adsorption and reduction of a metal complex can be simultaneously performed in parallel to each other, thereby enabling the number of steps required for forming the electrode layer to be decreased.

According to the invention of the application, the solid electrolyte form is a tubular or cylindrical solid electrolyte form and that the metal salt solution is caused to pass through the solid electrolyte form by osmosis is also an electrode forming method performed in either of a step (1) or a step (2) mentioned below. In the step (1), the solid electrolyte form is immersed in the reducing agent solution so that the outer side surface of the solid electrolyte form is in contact with the reducing agent solution and the metal salt solution is caused to flow in a space on the inner side of the solid electrolyte form to cause the metal salt solution to pass through the solid electrolyte form by osmosis to thereby deposit a metal on the outer side surface of the solid electrolyte form. In the step (2), the solid electrolyte form is immersed in the metal salt solution so that the outer side surface of the solid electrolyte form is in contact with the metal salt solution and the reducing agent solution is caused to flow in a space on the inner side of the solid electrolyte form to thereby cause the metal salt solution to pass through the solid electrolyte form by osmosis to thereby deposit a metal on the inner side surface of the solid electrolyte form. With the electrode forming method adopted, a metal salt or a reducing agent consumed in deposition of the metal on the outer side surface or inner side surface of a tubular or cylindrical solid electrolyte form can be supplied into the interior of the tube without interruption, thereby enabling an electrode layer having a large electrode surface area to be obtained without strictly adjusting a concentration of the metal salt solution or the reducing agent solution. Since the electrode forming method enables adsorption and reduction of a meal complex to be simultaneously performed in parallel to each other, the number of steps required for forming an electrode layer can be reduced, thereby enabling an electrode to be formed with simplicity and ease.

### BRIEF DESCRIPTION OF THE DRAWING

FIG. 1 is a schematic view of one embodiment of the invention.

FIG. 2 is a schematic view of the other embodiment of the invention.

### BEST MODE FOR CARRYING OUT THE INVENTION

Description will be given of the invention using the accompanying figures, while it should be understood that the invention is not limited thereto. The invention is directed to an electrode forming method, in which a metal salt solution and a reducing agent solution are disposed on respective both sides of a solid electrolyte form and the metal salt solution is caused to pass through the solid electrolyte form by osmosis to thereby deposit a metal near the interface on the reducing agent solution side of the solid electrolyte form.

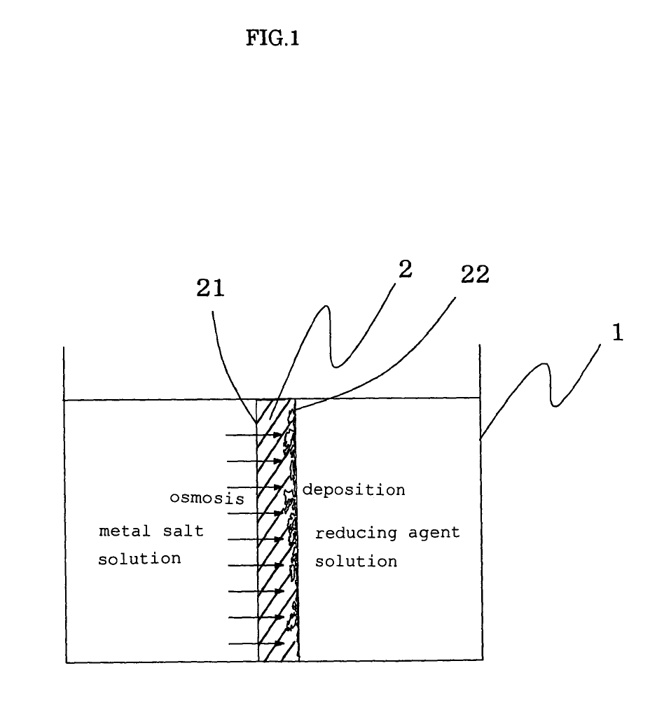

FIG. 1 is a view of one embodiment of the invention and to be concrete, a schematic sectional view of an embodiment of an electrode forming method of the invention in which a metal salt solution and a reducing agent solution are disposed on respective both sides of a film-like solid electrolyte form in a box type vessel. The solid electrolyte form 2 is a solid electrolyte form with two surfaces in the shape of a film. The solid electrolyte form 2 is installed in the vicinity of the center of the box type vessel 1 open upwardly and the metal salt solution and the reducing agent solution are disposed on respective both sides of the solid electrolyte form 2 so as to be separated by the solid electrolyte form 2. The metal salt solution is caused pass through the interface 21 of the solid electrolyte form on the metal salt solution side, transported to the reducing agent solution side and further transported to the interface 22 of the solid electrolyte form on the reducing salt side. With the transport, a metal complex in the metal salt solution react with a reducing agent in the reducing agent solution to deposit a metal on the interface 22 of the solid electrolyte form on the reducing agent solution side, and the metal salt solution is continuously transported to the reducing solution side to deposit a metal and to thereby grow a metal layer in a direction toward the metal salt solution side with the result that a fractal, non-smooth metal layer is formed. Furthermore, a film on which a fractal, non-smooth metal layer has been formed is turned inside out and a fractal, non-smooth electrode can be formed in a similar manner on the other side. Since the fractal, non-smooth metal layer has a large surface area of a metal layer (an electrode surface area) at the interface between the solid electrolyte layer and the metal layer, a larger electric double layer capacity and more electrode active points are provided as compared with a smooth metal layer; therefore, ions transported, when the metal layer is supplied with a current as an electrode of an actuator element, increases to thereby increase a displacement quantity as the actuator element. The actuator element forms a state where the solid electrolyte layer and the metal layer are joined to each other. Note that the term, surface area, in the application means an area of the interface between the solid electrolyte layer and the metal layer.

### (Solid Electrolyte Form)

A solid electrolyte form used in the invention is not specifically limited and any of shapes can be adopted as far as the solid electrolyte form can serve as a partition between the metal salt solution and the reducing agent solution and can work in order to facilitate osmosis of the metal salt solution and deposition of a metal to occur in a uniform manner through and on the solid electrolyte form, it is preferably to use the solid electrolyte form with a uniform film thickness. As a solid electrolyte form with a uniform film thickness, there can be used a solid electrolyte form having two surfaces opposite each other, that is a solid electrolyte form in the shape of a plate or a film, and furthermore, the form in the shape of a tube or a cylinder. The opposite two surfaces has only to be two surfaces facing each other and a surface itself may be either a flat surface or a curved surface and may be r either a smooth surface or a rough surface. Note that no specific limitation is placed on the thickness of a solid resin form and the thickness can be 10 cm or less or preferably 2 cm or less.

Since it is easy for a metal salt solution to pass through a solid electrolyte form by osmosis and to work the form with ease, the form is preferably constituted of an ion exchange resin as a main component. No specific limitation is placed on an ion exchange resin and known ion exchange resins can be adopted and examples thereof that can be used include: resins obtained by introducing a hydrophilic functional group such as a sulfonic acid group or a carboxylic group into polyethylene, polystyrene or fluororesin. Particularly, as the ion exchange resin, it is preferable to use a cation exchange resin obtained by introducing a sulfonic acid group and/or a carboxylic group into a fluororesin as a polymer actuator element since a stiffness is proper, an ion exchange quantity is large with good durability against chemical resistance and repeated bending. Note that an ion exchange capacity of the cation exchange resin is preferably in the range of from 0.8 to 3.0 meq/g and more preferably in the range of 1.4 to 2.0 meq/g in order to attain a large internal displacement quantity as an actuator element. As such resins, there can be used a perfluorosulfonic acid resin (Nafion, manufactured by DuPont), a perfluorocarboxylic acid resin (Flemion manufactured by Asahi Glass Co., Ltd.), ACIPLEX (manufactured by Asahi Kasei Corporation) or NEOSEPTA (manufactured by TOKUYAMA Corp.).

### (Metal Salt Solution)

No specific limitation is imposed on a metal salt solution used in the invention regardless of any shape of a solid electrolyte form as far as a metal salt is dissolved and the metal salt solution may contain a small amount of a solvent and an additive, which have been known. It is preferable to use an inorganic salt, an organic salt of a metal or a complex of a metal as the metal salt and it is preferable to use a metal complex such as a gold complex, a platinum complex, a palladium complex, a rhodium complex or ruthenium complex since a metal small in ionization tendency is electrochemically stable, and since deposited metal is used as an electrode in water, it is preferable to use a metal complex constituted of a noble metal good in electric conductivity and rich in electrochemical stability and more preferable to use a gold complex constituted of gold comparatively harder in electrolysis. While the metal salt solution is not specifically limited with respect to a solvent thereof, it is preferable to use a solvent including water as a main component since a metal salt is easily dissolved in the solvent and easy in handling and the metal salt solution is preferably a metal salt solution. Therefore, the metal salt solution is preferably a metal complex aqueous solution, particularly preferably a gold complex aqueous solution or a platinum complex aqueous solution and more preferably a gold complex aqueous solution. No specific limitation is imposed on a metal salt concentration of the metal salt solution as far as a sufficiently more quantity of a metal salt is contained than a metal quantity to be deposited on a solid electrolyte form and it is also possible to use a concentration equivalent to a metal salt solution used in a case of forming an electrode by means of usual electroless plating.

### (Reducing Agent Solution)

No specific limitation is imposed on a reducing agent solution used in the invention regardless of a shape of a solid electrolyte form as far as a reducing agent is dissolved. As reducing agents, there can be used a reducing agent properly selected according a kind of a metal salt used in a metal salt solution passing through the solid electrolyte form by osmosis and examples thereof that can be used include: sodium sulfite, hydrazine, sodium borohydride and others. Note that when a metal salt is reduced, an acid or an alkali may be added if required. While a concentration of the reducing agent solution has only to include a sufficient quantity in order to attain a metal quantity to be deposited by reduction of a metal complex and no specific limitation is imposed on a concentration, it is possible to use a concentration of a metal salt solution equivalent to that of a metal salt solution used in a case of forming an electrode by means of usual electroless plating.

### (Osmosis of Metal Salt Solution)

A method for forming an electrode of the invention is performed in a procedure in which the metal salt solution is caused to pass through the solid electrolyte form by osmosis, reduction of a metal salt is conducted near the interface between the solid electrolyte form on the reducing agent solution side thereof and the reducing agent solution, a metal is deposited and grown near the interface by means of reduction to thereby form an electrode. As methods for causing a metal salt solution to pass through a solid electrolyte form by osmosis, no specific limitation is placed on a particular method regardless of a shape of a solid electrolyte and examples thereof that can be used include: known osmotic methods such as a method using electrophoresis, a method using a difference in concentration of a metal salt solution and a reducing agent solution (osmotic pressure) and a method using a difference in temperature or the like between a metal salt solution and a reducing agent solution. The method for causing a metal salt solution to pass through a solid electrolyte form properly by osmosis can properly select a kind of a metal used in a metal salt solution and a concentration thereof, according to a kind of a reducing agent used in a reducing agent and a concentration thereof. In a case where osmosis of a metal salt solution is performed by means of a method using a difference in temperature, a liquid temperature of a metal salt solution is set higher than a liquid temperature of a reducing agent by 5° C. or more in the range of temperatures with the higher limit of a boiling point or lower in which solutions show good fluidity, thereby enabling a metal salt solution to be caused to pass through a solid electrolyte by osmosis with ease in a short time.

### (Tubular and Cylindrical Solid Electrolyte Form)

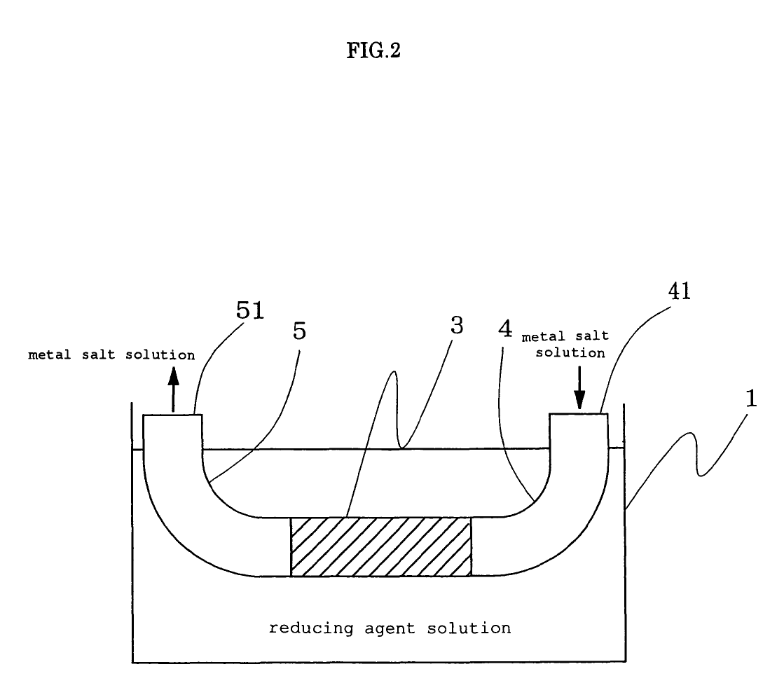

FIG. 2 is a schematic view of the other embodiment of the invention and a view showing an example of the embodiment of a tubular or cylindrical solid electrolyte form used in the invention. To be more detailed, FIG. 2 is a schematic view of the embodiment in a case of a step of depositing a metal near the interface between the outer side surface of the solid electrolyte form 3 and the reducing agent solution in a procedure in which the tubular electrolyte form 3 is immersed in a reducing agent solution so that the outer side surface of the tubular electrolyte form 3 is in contact with the reducing agent solution and a metal salt solution is caused to flow in a space on the inner side of the solid electrolyte form 3 to thereby cause the metal salt solution to pass by osmosis in a direction toward the outer side surface of the solid electrolyte 3. The solid electrolyte form 3 is equipped with a conduit pipe 4 for introducing the metal salt solution and a drainage pipe 5 for discharging so as to be connected to respective opening portions. The metal salt solution is introduced from the end portion 41 of the conduit pipe 4 to thereby be fed to the space on the inner side of the solid electrolyte form 3 and to be discharged from the end portion 51 of the drainage pipe 5. The metal salt solution is transported to the space of the solid electrolyte form 3 and caused to pass toward the outer side surface of the solid electrolyte form 3 by osmosis and metal salt moved by osmosis is reduced near the outer side surface of the solid electrolyte form 3 to form an electrode, which is a metal layer.

In a case where the tubular or cylindrical solid electrolyte form is immersed into a reducing agent solution so that the outer side surface of the electrolyte form is in contact with the reducing agent solution and the metal salt solution is caused to flow on the inner side of the solid electrolyte form to cause the metal salt solution to pass through the solid electrolyte form by osmosis and to thereby adopt a step of depositing a metal on the outer side surface of the solid electrolyte form, a metal salt solution for an electrode of the invention is caused to flow on the inner side of the tubular solid state form to thereby cause the metal salt solution to pass through the solid electrolyte form; therefore, it is possible to keep a metal salt concentration almost constant in the space on the inner side of the solid electrolyte form by a flow of a new metal salt solution even if a metal salt concentration in the metal salt solution in the space on the inner side is reduced by deposition of a metal. Hence, since in this case, no necessity arises for adjusting a metal salt solution in consideration of reduction in metal concentration due to deposition, an operation in a step is easy. No specific limitation is imposed on a particular method causing a metal salt solution to flow in the space on the inner side of the tubular solid electrolyte form and any of methods may be used as far as it is a method causing a metal salt solution to flow. Note that an electrode forming method of the invention using a tubular or cylindrical solid electrolyte form is preferably an electrode forming method in which circulation tubes for causing a metal salt solution to flow and circulate is attached to both ends of the tubular or cylindrical solid electrolyte form to which a pump for circulating a metal salt solution, a metal salt solution tank in which a temperature of the metal salt solution can be adjusted are connected to the solid electrolyte form with the circulation tubes interposed therebetween and the metal salt solution can be circulated.

FIG. 2 is a view showing the embodiment of a production method for an electrode of the invention in which a metal salt solution is caused to flow on the inner side of the tubular solid electrolyte form to thereby cause the metal salt solution to pass through the solid electrolyte by osmosis, while in a production method for an electrode of the invention, it is possible to adopt an embodiment in which a reducing agent solution is caused to flow on the inner side of the tubular solid electrolyte form to thereby cause the metal salt solution to pass through the solid electrolyte. Since in a case of the method, a metal salt solution is caused to pass through the tubular solid electrolyte form in a direction to the inner side surface to form a metal layer, which is an electrode, on the inner side surface, it is possible to keep a metal salt concentration almost constant in the space on the inner side of the solid electrolyte form by a flow of a new metal salt solution even if a reducing agent concentration in the reducing agent solution in the space on the inner side is reduced by deposition of a metal. Hence, since in an electrode forming method of the invention, no necessity arises for adjusting a reducing agent solution in consideration of reduction in reducing agent concentration due to deposition, an operation in a step is easy.

### (Actuator Element)

By using a electrode forming method of the invention, a laminate composed of a solid electrolyte layer and a metal electrode layer is formed on a solid electrolyte form, the laminate can be used as an actuator element as it is or by properly applying a known method thereto. Hence, it is allowed that a metal is deposited on the reducing agent solution side of the solid electrolyte form to thereby form an electrode on the solid electrode form and thereafter, a cleaning step using a cleaning agent is performed or an ion exchange resin form on which a metal electrode is formed is irradiated with laser light to thereby remove part of a metal electrode and to thereby provide an insulating zone or zones between the electrodes. Cations included in an ion exchange may be replaced with alkyl ammonium ions. Since the laminate is in the shape of a tube or a cylinder, there are spaces connected with each other in the vicinity of the center thereof, while a solid electrolyte or rubber may be packed into the spaces to thereby form a polygonal cylinder, a circular cylinder or the like.

By adopting an electrode forming method of the invention, there can be obtained a laminate with a thickness of 1 mm or more, and composed of a solid electrolyte layer and electrode layer. In a case where an electrode layer with a thickness of 1 mm on a solid electrolyte form with an electroless plating method, in which a set of an adsorption step, a reduction step and a cleaning step, which is a conventional set, are repeated each step as an independent step, a solid electrolyte form is necessary to be immersed in a metal salt solution for the full day in order to sufficiently adsorb a metal salt in the first adsorption step and the solid electrolyte molded electrode is necessary to be immersed in a reducing agent solution for the three days or more in order to sufficiently deposit a metal in the first reduction step. By further repeating a pair of the adsorption step and the reduction step, speeds of adsorption and reduction are decreased in the second pair and pairs subsequent thereto and more times in immersion is increasingly required in a later pair. Therefore, by means of a conventional method, it is difficult obtaining a laminate with a thickness of 1 mm or more composed of a solid electrolyte layer and an electrode layer and it is more difficult obtaining a laminate composed of a large sized solid electrolyte layer and a large sized electrode layer. Since a laminate with a thickness of 1 mm or more, composed of a solid electrolyte layer and an electrode layer can exert a larger force by applying a voltage between the electrode layers, as a laminate capable of being driven as an actuator element, the laminate can be usefully used. A laminate with a thickness of 1 mm or more, composed of a solid electrolyte layer and an electrode layer can be preferably used as an electrochemical device.

With an electrode forming method of the invention adopted, there can be obtained a laminate with a thickness of 1 mm or more, composed of a solid electrolyte layer and an electrode layer and furthermore, particularly, a laminate with a thickness of 2 mm or more, composed of a solid electrolyte layer and electrode layers. With an electrode forming method of the invention adopted, there can be obtained a laminate that can be driven as an actuator element, with a thickness of 5 mm or more, composed of a solid electrolyte layer and electrode layers. A laminate obtained by using an electrode forming method of the invention can be used for various kinds of devices or apparatuses since the laminate can work as an actuator. A laminate with a thickness of 1 mm or more that can be driven as an actuator element, and composed of a solid electrolyte layer and electrode layers can be used in applications to general machine and equipment, and is advantageous because of generation of neither vibrations nor sounds as compared with a motor.

In a case where, for example, an electrode layer is provided on the outer surface of a tubular laminate so as to be shrinkable or extendable by means of an electrode forming method of the invention and an opposite electrode is provided as a separate member, such a combination can be used as an actuator element causing a linear displacement in itself. In a case where, for example, an electrode layer is provided on the outer surface of a tubular laminate by means of an electrode forming method of the invention and the electrode layer is partly removed using an excimer laser to thereby form a structure of an insulating zone sandwiched between electrodes, which are a pair of electrodes opposite each other, such a structure can be used as an actuator causing bending deformation in itself. The actuator element causing a linear displacement or bending deformation can be used as a driving part generating a linear driving force or a driving part generating a driving force for moving a member over tracks each in the shape of a circular arc. Moreover, the actuator element can be used as a pressing part giving a liner motion.

That is, the actuator element can be preferably employed in a driving part generating a linear driving force or a driving part generating a driving force for moving a member over tracks each in the shape of a circular arc or in a pressing part giving a linear or curved motion in OA equipment; an antenna; devices holding a human being such as a bed and a chair; medical equipment; an engine; an optical equipment; a fixing tool; a side trimmer; a vehicle; a lifter; a food processor; a cleaner; a measuring instrument; an inspection instrument; control equipment; a working machine; a forming machine; electronic equipment; an electron microscope; an electrically operated shaver; an electrically operated toothbrush; a manipulator; a mast; a play apparatus; amusement equipment; an automobile simulator; a vehicle crew holding device; and an aircraft attached equipment extender. The actuator element can be preferably employed in a driving part generating a linear driving force or a driving part generating a driving force for moving a member over tracks each in the shape of a circular arc or in a pressing part giving a liner motion in, for example, a valve, a brake device; or a lock-up device generally used in all kinds of machines including the equipment, for example OA equipment and an inspection instrument. In addition to the apparatus, device, equipment or an appliance, the actuator element can be preferably used in a driving part of a positioning device; a driving part of an attitude control device; a driving part of a lifter; a driving part of a transport apparatus; a driving part of a moving apparatus; a driving part of an adjustment device for a quantity, a direction or the like; a driving part of an regulation device for a shaft and others; a driving part of a guiding apparatus; and a pressing part of a press apparatus. Since the actuator element can give a rotational motion, the actuator element can also be used as a driving part of a change-over device; a driving part of a reversing apparatus for a transport article; a driving part of a take-up apparatus for a wire; a driving part of a traction apparatus; and a driving part of a swing device for oscillation, leftward or rightward.

The actuator element can be preferably used in, for example, a driving part of an ink jet section in an ink jet printer such as a CAD printer; a driving part displacing an optical axis of a light beam in a printer; a head driving part of a disk driving device such as an external storage apparatus; and a driving part of a pressure contact force adjustment means for paper in a paper feed device in an image forming apparatus such as a printer, a copying machine and a facsimile.

The actuator element can be preferably used in, for example, a driving part of a driving mechanism moving and setting a measurement part and a feeding part in moving a high frequency feeding part on a frequency shared antenna for radio astronomy or the like to the second focal point; and a driving part of a lift mechanism in a mast or an antenna such as a vehicle on-board pneumatic mast.

The actuator element can be preferably used in, for example, a driving part of a massage part of a massage machine in the shape of a chair; a driving part of a nursing bed or a medical bed; a driving part of an attitude controller for an electric reclining chair; a driving part of a telescoping rod freely making a backrest and an ottoman of a reclining chair used in a massage machine or an easy chair stand upright or lie near flat; a driving part used in a swing device of a backrest or a legrest of a reclining chair of furniture on which a human being is held, or a bed proper of a nursing bed such as a backrest or a legrest of a chair or a nursing bed; and a driving part for an attitude controller of an upright chair.

The actuator element can be preferably used in, for example, a driving part of an inspection instrument; a driving part of a pressure measuring instrument for a blood pressure used in an external blood treatment apparatus or the like; a driving part of a catheter, an endoscope device or a forceps; a driving part of a cataract operation device using ultra waves; a driving part of an exercise apparatus such as a jaw exercise apparatus; a driving part of a means for relatively telescoping a chassis member of an invalid person hoist; and a driving part for use in a vertical movement, a horizontal movement or attitude control of a nursing bed.

The actuator element can be preferably used in, for example, a driving part of a vibration isolator for attenuating vibrations transmitted from a vibration origin such as an engine to a vibration receiving portion; a valve operation driving part of an intake/exhaust valve of an internal combustion engine; a driving part of a fuel controller of an engine; and a driving part of a fuel injection device of an engine such as a diesel engine.

The actuator element can be preferably used in, for example, a driving part of a correcting device for an imaging device attached with a hand-caused vibration correcting capability; a driving part of a lens driving mechanism of a home videocamera lens; a driving part driving a moving lens group of an optical equipment such as a still camera or a videocamera; a driving part of an autofocussing part of a camera; a driving part of a lens barrel used in an imaging device such as a camera or a videocamera; a driving part of an autoguider capturing light in an optical telescope; a driving part of a lens driving mechanism or a lens barrel of an optical device having two optical systems such as a stereoscopic camera or binocular glasses; a driving part or a pressing part giving a compressive force to a fiber for wavelength conversion of a fiber type variable wavelength filter used in optical communication, optical information processing or optical measurement; and a driving part of an optical axis alignment device; and a driving part of a shutter mechanism of a camera.

The actuator element can be preferably used in, for example, a pressing part of a fixing tool caulking and fixing a hose metal member to a hose proper.

The actuator element can be preferably used in, for example, a driving part of a spiral spring of suspension in an automobile; a driving part of a fuel filler lid opener unlocking a fuel filler lid of a vehicle; a driving part for driving for extension or retraction of a bulldozer blade; and a driving part of a driving device for automatically engaging and disengaging a clutch.

The actuator element can be preferably used in, for example, a driving part of a vertical movement device of a seat lifter attached wheel chair; a driving part of a level difference correcting lifter; a driving part of a lift transport apparatus; a driving part of a medical bed, a electrically operated bed, an electrically operated table, an electrically operated chair, a nursing bed, a lifting table, a CT scanner, a cabin tilt device of a truck, a driving part for vertical movement of various kinds of lifting machine such as a lifter; and a driving part of a load unload apparatus of a heavy load transport special vehicle.

The actuator element can be preferably used in, for example, a driving part of a discharge quantity adjusting mechanism in a food raw material discharge nozzle of a food processor.

The actuator element can be preferably used in, for example, a driving part of lifting a carriage and a cleaning part of a cleaner.

The actuator element can be preferably used in, for example, a driving part of a measuring section of a three dimensional measuring instrument measuring a profile of a surface; a driving part of a stage device; a driving part of a sensor section such as a detection system for a tire dynamic characteristic; a driving part of a device giving an initial speed to an evaluation instrument for a shock response of a force sensor; a driving part of a piston driving device for a piston cylinder of an apparatus including an in-hole water permeability tester; a driving part for moving a light collection tracking type power generator in a direction of an elevation angle; a driving part of a tuning mirror oscillation device of a sapphire laser oscillation wavelength change-over mechanism in a measuring apparatus including a gas concentration measuring device; a driving part of a XYθ table in a case where an alignment is necessary in an inspection instrument for a print circuit board or an inspection instrument for a flat panel display such as liquid crystal or PDP; a driving part of an adjustable aperture apparatus used in an electron beam (E beam) or a focused ion beam (FIB) system; a driving part of a holding device or a detection part of a specimen to be measured in a flatness measuring instrument; and a driving part of a precision positioning apparatus such as a device required in assembly of a micro device, a semiconductor exposure device, a semiconductor inspection instrument or a three dimensional measurement instrument.

The actuator element can be preferably used in, for example, a driving part of an electric shaver and an electric toothbrush.

The actuator element can be preferably used in, for example, a driving part of a focus depth adjusting device in a reading optical system common to an imaging device for a three dimensional subject or a CD and DVD; a driving part of a variable mirror altering a focal point with ease by deforming a shape of a driven object surface as an active curved surface using plural actuators to thereby form a desired curved surface approximately; a driving part of a disk device capable of linearly moving a moving part having an at least one magnetic head of an optical pick-up or the like; a driving part of a head transport mechanism of a magnetic tape head actuator element assembly in a linear tape storage system or the like: a driving part of an image forming apparatus applied to a copying machine, a printer, a facsimile or the like of an electrophotographic type; a driving part of a mounting part of a magnetic head or the like, a driving part of an optical disk master exposure apparatus driving and controlling converging lens group along an optical axis direction; a driving part of a head driving means driving an optical head; a driving part of a information recording reproduction apparatus performing recording information onto a recording medium or playback of information recorded on the recording medium; and a driving part for a switching operation of a circuit breaker (power distribution circuit breaker).

The actuator element can be preferably used in, for example, a driving part of a press molding vulcanizing apparatus for a rubber composition; a driving part of parts alignment device aligning transported parts in a single line, in a single layer or a predetermined positions; a driving part of a compression molding apparatus; a driving part of a holding mechanism of a welding apparatus; a driving part of bag filling machine; a driving part of a working machine such as a machining center, a molding machine such as an injection molding machine and a press machine; a driving part of a fluid coater such as a printing apparatus, a coating device and a lacquer spray device; a driving part of a manufacturing apparatus manufacturing a cam shaft or the like; a driving part of a hanging apparatus for a covering material; a driving part of a fringe tuft controller in a shuttleless loom; a driving part of a needle driving system of a tufting machine, a looper driving system, or a knife driving system of a tufting machine; a driving part of a cam grinding machine or a polishing apparatus performing polishing parts such as super precise worked parts; a driving part of a controller of a healder frame in a loom; a driving part of an opening device forming an opening portion in warps for inserting a weft in a loom; a driving part of a protective sheet peeling device used for a semiconductor substrate or the like; a driving part of a yarn guiding device; a driving part of an assembly apparatus of a CRT electron gun; a driving part of a shifter fork driving selection linear control apparatus used in a torsion lace machine for manufacturing a torsion lace used in applications to cloth edge decoration, a table cloth, a seat cover and the like; a driving part of a horizontal movement mechanism of an anneal window driving device; a driving part of a holding arm of a glass melting fore furnace; a driving part for moving a rack of an exposure apparatus forward or backward for use in a method forming a fluorescent surface of a color picture tube; a driving part of a torch arm of a ball bonding device; a driving part driving a bonding head in directions X and Y; a driving part in an mounting step for mounting chip parts or a measurement inspection step for measuring chip parts with a probe; a vertical driving part of a cleaning tool holder of a substrate cleaning apparatus; a driving part moving a detection head forward or backward with which a glass substrate is scanned; a driving part of a positioning device of an exposure apparatus transferring a pattern onto a substrate; a driving part of a fine positioning device of the submicron order in the precision working field; a driving part of a positioning device of a measuring instrument for a chemical mechanical polishing tool; a positioning driving part of a stage device suitable for an exposure apparatus and a scanning exposure apparatus used in fabricating circuit devices such as semiconductor circuit devices or liquid crystal display devices in a lithography step; a driving part of a means for transport or positioning of a work; a driving part for positioning or transporting a reticle stage or a wafer stage; a driving part of a precision positioning stage apparatus in a chamber, a driving part of a positioning apparatus for a work piece or a semiconductor wafer in a chemical mechanical polishing system; a driving part of a semiconductor stepper apparatus; a driving part of a device for correctly positioning a working machine in installation area; a driving part of a passive and active vibration isolation device for use in various kinds of equipment represented by a working machine such as an NC machine and a machining center or a stepper in the IC industry field; a driving part displacing a reference lattice plate of a light beam scanning apparatus in an exposure apparatus or the like used in a lithography step for production of semiconductor devices or liquid crystal devices toward an optical axis of the light beam; and a driving part of a transport apparatus transporting a work into a work treatment unit in a direction traversing a conveyor.

The actuator element can be preferably used in, for example, a driving part of a positioning device for a probe of a scanning probe microscope such as an electron microscope; and a driving part of a specimen fine positioning device for an electron microscope.

The actuator element can be preferably used in, for example, a driving part of a joint mechanism represented by a wrist of each of robots including an automatic welding robot, an industrial robot and a nursing robot, or a robot arm in a manipulator; a driving part of a joint other than a direct driving type; fingers proper of a robot; a driving part of a motion conversion mechanism of a slide opening closing chuck device used as a hand of a robot or the like; a driving part of a micro manipulator for operation of a micro cell operation or operation on a micro object into an arbitrary state in an assembly working of micro parts; a driving part of an electric-motored artificial limb or the like having plural fingers capable of opening or closing; a driving part of a handling robot; a driving part of a make-up tool; and a driving part of a powered suit.

The actuator element can be preferably used in, for example, a pressing part of a press apparatus pressing the upper rotational blade or the lower rotational blade of a side trimmer.

The actuator element can be preferably used in, for example, a driving part of a character or the like in a play device such as a pachinko (pinball game machine); a driving part of an amusement equipment such as a doll or a pet robot; and a driving part of an automobile simulation apparatus.

The actuator element can be preferably used in, for example, a driving part of a valve generally used in all machines including the equipment mentioned above and examples thereof include: a driving part of a valve of a re-liquefaction apparatus for vaporized helium gas; a driving part of a pressure sensitive control valve of a bellows type; a driving part of an opening device driving a heald frame; a driving part of a vacuum gate valve; a driving part of a solenoid driven control valve for a fluid pressure system; a driving part of a valve into which a motion transmission device is incorporated using a pivot lever; a driving part of a valve of variable nozzle of a rocket; a driving part of a suck-back valve; and a driving part of a pressure adjusting valve.

The actuator element can be preferably used in, for example, a pressing part of a brake generally used in all machines including the equipment mentioned above and examples thereof that can be preferably used include: a pressing part of a brake device used in a brake or an elevator for emergency, safety and security, and staying static; and a pressing part of a brake structure or a brake system.

The actuator element can be preferably used in, for example, a pressing part of a lock-up device generally used all machines including the equipment mentioned above and examples thereof that can be preferably used include: a pressing part of a mechanical lock-up device; a pressing part of a steering lock-up device for a vehicle; and a pressing part of a power transmission apparatus playing additional double roles of a load limiting mechanism and a coupling and releasing mechanism.

### EXAMPLES

There are shown examples and comparative examples of the invention, while it should be understood that the invention is not limited to them.

### Example 1

A film-like fluororesin-based ion exchange resin form with a film thickness of 200 μm (trade name: Flemion, made from perfluorocarboxylic acid resin and manufactured by Asahi Glass Co., Ltd. with an ion exchange capacity of 1.44 meq/g) was used as a solid electrolyte form, both surfaces of the ion exchange resin molded product film were roughened using alumina particles having a grain size of #800, and thereafter the ion exchange resin molded product was placed in a known plastic vessel in the shape of a box open at the top thereof so that the ion exchange resin molded product working as a partition in the plastic vessel, wherein a space on one side of the partition was filled with a dichlorophenanthroline gold aqueous solution (with a concentration of 1.0 wt %), while a space on the other side was filled with a sodium sulfite aqueous solution (with a concentration of 5 wt %). The dichlorophenanthroline gold aqueous solution was kept at a temperature higher than the sodium sulfite aqueous solution by 5° C. and the dichlorophenanthroline gold complex was reduced for 6 hours to thereby deposit gold near the surface on the sodium sulfite side and to form an electrode, and then the film (the ion exchange resin molded product) on which the electrode was formed in advance was reversed to form an electrode in a similar way on the other surface thereof from the surface on which the electrode was formed in advance. The ion exchange resin molded product on both side, facing each other, of which were cut into a pieces each with a size of 1.0 mm×8 mm to obtain an actuator of Example 1.

### Example 2

An actuator element of Example 2 was obtained in a similar way to that in Example 1 with the exception that in Example 2, a fluororesin-based ion exchange resin molded product with an ion exchange capacity of 1.80 meq/g (trade name: Flemion, made from perfluorocarboxylic acid resin and manufactured by Asahi Glass Co., Ltd.) was used instead of the fluororesin-based ion exchange resin molded product with an ion exchange capacity of 1.44 meq/g (trade name: Flemion, made from perfluorocarboxylic acid resin and manufactured by Asahi Glass Co., Ltd.).

### Example 3

A fluororesin-based ion exchange resin (trade name: Flemion, made from perfluorocarboxylic acid resin and manufactured by Asahi Glass Co., Ltd. with an ion exchange capacity of 1.44 meq/g) was molded into a tube by means of an extrusion molding method to thereby obtain a perfluorocarboxylic acid tube (with an ion exchange capacity of 1.44 meq/g, an inner diameter of 0.57 mm and an outer diameter of 0.65 mm), plastic tubes (made from silicone) with the same inner diameter and the same outer diameter as the perfluorocarboxylic acid tube were attached to both ends of the perfluorocarboxylic acid tube and the perfluorocarboxylic acid tube was immersed in a sodium sulfite aqueous solution (having a concentration of 10 wt %) with which a known glass vessel in the shape of a box open at the top thereof was filled. The dichlorophenanthroline gold aqueous solution (having a concentration of 1.0 wt %) was poured into one tube made from silicone attached to the perfluorocarboxylic acid tube and then the dichlorophenanthroline gold aqueous solution (having a concentration of 1.0 wt %) was circulated using a known tube pump. The dichlorophenanthroline gold aqueous solution was circulated for 8 hours while being kept at temperature higher than the sodium sulfite aqueous solution by 5° C. to thereby deposit gold near the outer side surface on the sodium sulfite side and to form an electrode. Then, the ion exchange resin molded product on the surface of which a gold electrode was formed was taken out from the sodium sulfite aqueous solution, followed by cleaning with water at 70° C. for 1 hour. The tubular ion exchange resin molded product on the outer side surface of which the electrode was formed was irradiated with excimer laser light from an excimer laser irradiation apparatus to form insulating grooves in a longitudinal direction (the length direction) of the tube and to thereby divide the electrode into 4 long narrow electrodes and the tube was cut into pieces with a length of 8 mm to thereby obtain an actuator of Example 3.

### Example 4

An actuator element of Example 4 was obtained in a similar way to that in Example 3 with the exception that in Example 4, a fluororesin-based ion exchange resin tube with an ion exchange capacity of 1.80 meq/g (trade name: Flemion, made from perfluorocarboxylic acid resin and manufactured by Asahi Glass Co., Ltd.) was used instead of the fluororesin-based ion exchange resin tube with an ion exchange capacity of 1.44 meq/g (trade name: Flemion, made from perfluorocarboxylic acid resin and manufactured by Asahi Glass Co., Ltd.).

### Comparative Example 1

Both surfaces of a film-like fluororesin-based ion exchange resin molded product with a film thickness of 200 μm (trade name: Flemion, made from perfluorocarboxylic acid resin and manufactured by Asahi Glass Co., Ltd. with an ion exchange capacity of 1.44 meq/g) were roughened using alumina particles having a grain size of #800, and thereafter the following steps (1) to (3) were repeated in 8 cycles to form a gold electrode on a surface of the ion exchange resin molded product. (1) An adsorption step was performed in which the ion exchange resin molded product was immersed in the dichlorophenanthroline gold aqueous solution for 12 hours to thereby cause dichlorophenanthroline gold complex to be adsorbed to the molded product, (2) a deposition step was performed in which the adsorbed dichlorophenanthroline gold complex was reduced in the sodium sulfite aqueous solution to form a gold electrode on the surface of the ion exchange resin molded product. In the course of reduction, a temperature of the aqueous solution was adjusted in the range of 60 to 80° C. and sodium sulfite was gradually added into the aqueous solution to continue for 6 hours for reduction of the dichlorophenanthroline gold complex. Then (3) a cleaning step was performed in which the ion exchange resin molded product was taken out from the aqueous solution, followed by cleaning with water at 70° C. for 1 hour. The ion exchange resin molded product on which the gold electrode was formed was cut into pieces with a size of 1.0 mm×8 mm to obtain an actuator of Comparative Example 1.

### Comparative Example 2

An actuator element of Comparative Example 2 was obtained in a similar way to that in Comparative Example 1 with the exception that in Comparative Example 2, a fluororesin-based ion exchange resin molded product with an ion exchange capacity of 1.80 meq/g (trade name: Flemion, made from perfluorocarboxylic acid resin and manufactured by Asahi Glass Co., Ltd.) was used instead of the fluororesin-based ion exchange resin molded product with an ion exchange capacity of 1.44 meq/g (trade name: Flemion, made from perfluorocarboxylic acid resin and manufactured by Asahi Glass Co., Ltd.).

### Comparative Example 3

A gold electrode was formed on a surface of an ion exchange resin molded product in a similar way to that in Comparative Example 1 with the exception that in Comparative Example 3, a fluororesin-based ion exchange resin tube (trade name: Flemion, made from perfluorocarboxylic acid resin and manufactured by Asahi Glass Co., Ltd. with an ion exchange capacity of 1.44 meq/g) instead of the film-like fluororesin-based ion exchange molded product was molded into a perfluorocarboxylic acid tube (with an ion exchange capacity of 1.44 meq/g, an inner diameter of 0.57 mm and an outer diameter of 0.65 mm) by means of a known extrusion molding method. The outer surface of the ion exchange resin molded product was roughened with alumina particles with a particle size of #800. The tubular ion exchange resin molded product on the outer surface of which an electrode was formed was irradiated with excimer laser light from an excimer laser irradiation apparatus to form insulating grooves in a longitudinal direction (the length direction) of the tube and to thereby laterally divide the electrode into 4 long narrow electrodes and the tube was cut into pieces with a length of 8 mm to thereby obtain an actuator element of Comparative Example 3.

### Comparative Example 4

An actuator element of Comparative Example 4 was obtained in a similar way to that in Comparative Example 3 with the exception that in Comparative Example 4, a fluororesin-based ion exchange resin tube with an ion exchange capacity of 1.80 meq/g (trade name: Flemion, made from perfluorocarboxylic acid resin and manufactured by Asahi Glass Co., Ltd.) was used instead of the fluororesin-based ion exchange resin tube with an ion exchange capacity of 1.44 meq/g (trade name: Flemion, made from perfluorocarboxylic acid resin and manufactured by Asahi Glass Co., Ltd.).

### (Evaluation)

An end of each electrode of the actuator element of each of Examples 1 and 2, and Comparative Examples 1 and 2 was connected to power supply using a lead wire interposed therebetween and a platinum plate was adopted as an opposite electrode. Then, each actuator element was held in water and in this state, applied with a voltage (with 0.1 Hz and a square wave of an amplitude 2.0 V) to thereby measure a displacement quantity. A pair of electrodes opposite each other of each of the actuator elements of Examples 3 and 4, and Comparative Examples 3 and 4 were used as a cathode and an anode, respectively, and an end of each electrode was connected to power supply using a lead wire interposed therebetween and a platinum plate was adopted as an opposite electrode. Then, each actuator element was held in water and in this state, applied with a voltage (with 0.1 Hz and a square wave of an amplitude 2.0 V) to thereby measure a displacement quantity. Note that each of the actuator elements of Examples 1 to 4, and Comparative Examples 1 to 4 was fixed at a point 6 mm from one end and a displacement quantity of a point 5 mm from the fixing point was measured and evaluated using the following criteria. Results of the measurement are shown in Table 1.

TABLE 1

| | | Examples | | | | Comparative Examples | | | |
|---|---|---|---|---|---|---|---|---|---|
| | | 1 | 2 | 3 | 4 | 1 | 2 | 3 | 4 |
| Ion exchange | | 1.44 | 1.80 | 1.44 | 1.80 | 1.44 | 1.80 | 1.44 | 1.80 |
| capacity (meq/g) | | | | | | | | | |
| Shapes | | Film | Film | Tube | Tube | Film | Film | Tube | Tube |
| Electrode | Number of | 1 | 1 | 1 | 1 | 3 | 3 | 3 | 3 |
| formation | steps | | | | | | | | |
| | Number of | 1 | 1 | 1 | 1 | 8 | 8 | 8 | 8 |
| | repetitions | | | | | | | | |
| | of the step | | | | | | | | |
| | or set of | | | | | | | | |
| | steps (cycles) | | | | | | | | |

| | | | | | | | | |
|---|---|---|---|---|---|---|---|---|
| Displacement | 1.0 | 2.0 | 0.5 | 0.8 | 1.0 | 2.0 | 0.5 | 0.8 |
| quantities (mm) | | | | | | | | |

The film-like actuator element of Example 1 has a displacement quantity of 1 mm, the same ion exchange capacity and the same displacement quantity as Comparative Example 1, which shows that the film-like actuator element of Example 1 is a polymer actuator showing good flexibility. The film-like actuator element of Example 2 has a displacement quantity of 2 mm and the same ion exchange capacity and the same displacement quantity as Comparative Example 2, which shows that the film-like actuator element of Example 2 is a polymer actuator showing good flexibility. The tubular actuator element of each of Examples 3 and 4 has the same ion exchange capacity and the same displacement quantity as Comparative Examples 3 and 4, which shows that each of the tubular actuator element of Examples 3 and 4 is a polymer actuator showing good flexibility.

Each of the actuator elements of Examples 1 to 4 on which an electrode was formed by means of a manufacturing method of the invention has a displacement quantity equal to that of each of the actuator elements of Comparative Examples 1 to 4, to which the actuator elements of Examples 1 to 4 correspond in terms of a shape of an ion exchange resin molded product and an ion exchange capacity, leading to a conclusion that no difference in displacement quantity was found between the case where an electrode was formed by means of a manufacturing method of the invention and the case where an electrode was formed by means of a conventional method. In Comparative Examples 1 to 4, a process for forming an electrode of an actuator as a conventional electrode forming method included 8 repetitions of the set of the adsorption step, the reduction step and the cleaning step. In contrast thereto, in Examples 1 to 4, a process for forming an electrode as an electrode forming method of the invention includes only a single step in which osmosis and reduction of a metal complex is performed with no repetition thereof. Hence, in Examples 1 to 4, a time consumed for forming an electrode was able to decrease to be on the order in the range of tenth to seventh thereof compared with Comparative Examples 1 to 4.

Since, in obtaining the actuator elements of Comparative Examples 1 to 4, a solid electrolyte form is, in order to form an electrode, necessary to be taken out from a solution in each of the adsorption step, the reduction step and the cleaning step, time and labor are required and even in case where the process was mechanically performed, an apparatus therefor would be necessary to be on a large scale. In contrast thereto, since the actuator elements of Examples 1 to 4 can be formed in a single step actually including the adsorption step and the reduction step and adsorption of a metal complex in necessary quantity can be ensured continuously, time and labor can be reduced and automation of the process is easily realized as compared with Comparative Examples 1 to 4, which were conducted with a conventional electrode forming method.

### INDUSTRIALLY APPLICABILITY

In manufacture of a laminate provided with a solid electrolyte layer and a electrode section, since the number of steps necessary for forming an electrode can be reduced by using an electrode forming method of the invention, a time required for manufacturing a laminate that can be used in an actuator element or the like can be greatly decreased and mass production of laminates can be made easy. A production of a laminate is completed by a single operation to take up a solid electrolyte immersed in a solution for adsorption and reduction, which makes it possible to reduce time and labor, thereby enabling manufacture of a laminate to be automated with ease.

1. An electrode forming method, in which a metal salt solution and a reducing agent solution are disposed on respective both sides of a solid electrolyte form and the metal salt solution is caused to pass through the solid electrolyte form by osmosis to thereby deposit a metal near the interface on the reducing agent solution side of the solid electrolyte form.

2. The electrode forming method according to claim 1, wherein the solid electrolyte form has two surfaces opposite each other.

3. The electrode forming method according to claim 1 in which the solid electrolyte form is a tubular or cylindrical solid electrolyte form and that the metal salt solution is caused to pass through the solid electrolyte form by osmosis is performed
in the step (1) in which the solid electrolyte form is immersed in the reducing agent solution so that the outer side surface of the solid electrolyte form is in contact with the reducing agent solution and the metal salt solution is caused to flow in a space on the inner side of the solid electrolyte form, to cause the metal salt solution to pass through the solid electrolyte form by osmosis and to thereby deposit a metal on the outer side surface of the solid electrolyte form or
in the step (2) in which the solid electrolyte form is immersed in the metal salt solution so that the outer side surface of the solid electrolyte form is in contact with the metal salt solution and the reducing agent solution is caused to flow in a space on the inner side of the solid electrolyte form to thereby cause the metal salt solution to pass through the solid electrolyte form by osmosis to thereby deposit a metal on the inner side surface of the solid electrolyte form.

4. A production method for an actuator element forming an electrode with the electrode forming method according to claim 1.

5. The production method for an actuator element forming an electrode with the electrode forming method according to claim 3.

6. A production method for a laminate composed of a solid electrode layer and a electrode layer from which an electrode was formed with the electrode forming method according to claim 3.

7. The production method for a laminate according to claim 6, wherein the solid electrolyte layer is an ion exchange resin layer.
